(19) United States
(12) Patent Application Publication
(10) Pub. No.: US 2003/0146011 A1
(43) Pub. Date: Aug. 7, 2003

(54) Housing for receiving electric and/or electronic assemblies

(76) Inventors: Bodo Thielmann, Herborn (DE); Marc Hartel, Reiskirchen (DE); Ralf Dahmer, Olpe (DE)

Correspondence Address: Pauley Petersen, Kinne & Erickson, Suite 365, 2800 West Higgins Road, Hoffman Estates, IL, 60195, US

(21) Appl. No.: 10/204,194

(22) PCT Filed: Jan. 20, 2001
(86) PCT No.: PCT/EP01/00670

(30) Foreign Application Priority Data
Feb. 18, 2000 (DE) 100 07 490.1

(51) Int. Cl. H02G 3/08

(52) U.S. Cl. 174/50

(57) ABSTRACT

The invention relates to a housing for receiving electric and/or electronic assemblies with two parallel plate-like covers which are connected to each other by means of profiled limbs extending vertically with respect to said covers. The profiled limbs are embodied as extruded/pressed profiled sections and are provided with moulded, undercut grooves which are formed as a single piece. The two profiled limbs facing the front side of the housing have an inner surface which is disposed in a vertical position with respect to the front side of the housing. The first undercut groove is built into said inner surfaces, being open in the direction of the inner side of the housing. In order to improve fixing possibilities for said housing, a bearing surface arranged perpendicular to the associated side of the housing is joined to the inner surface at a right angle thereto; a second groove which is open towards the rear side of the housing is built into the bearing surface; a holder is maintained in the first and/or second groove in order to secure the supports for the sub-assemblies; and the holder can be displaced in the direction of the depth of the housing towards the longitudinal extension of said groove when mounted in the first groove and can be displaced in a perpendicular position with respect to the longitudinal extension of the groove in the direction of the width of the housing when mounted in the second groove.

The invention relates to a housing for containing electric and/or electronic assemblies, with two parallel plate-shaped covers, which are connected to each other by means of profiled legs extending vertically with respect to the planes of the covers, in which the profiled legs are embodied as extruded profiled sections and are provided with undercut grooves formed onto and of one piece with them, in which the two profiled legs oriented toward the front of the housing each have an inner surface extending vertically with respect to the front of the housing, and a first undercut groove, which opens toward the interior of the housing, is let into these inner surfaces.

A housing of this kind is known from DE 42 33 401 C1. In the invention disclosed therein, two vertical covers embodied as plates are connected to each other by means of four horizontally disposed profiled legs. The profiled legs are embodied as extruded profiles and have a screw channel extending in the longitudinal direction of the profiles. The covers are provided with screw receptacles flush with the screw channel entry so that they can be screwed to the profiled legs. Fastening receptacles are let into the profiled legs. The profiled legs also have a recessed fastening groove to which assemblies on the interior of the housing can be fastened.

wall section 82. The top section 81 has projections 83 formed onto it, which protrude toward the flange 11. Each fastener 80 has two projections 83. The projections 83 engage in the openings 55 and 12 of the edges 52 and the flanges 11. When installed, the fastener 80 rests with its top section 81 against the top of the cover 10 and the edge 52. The wall 51 rests against the outside of the side wall 50. Because the round projections 83 are of a flexible material, they are clamped over their entire circumference against the inner contour of the openings 55 and 12. This permits a play-free attachment of the side wall 50. It is also possible for the projections 83 to be embodied conically so that from the point at which they adjoin the top section 81, they taper toward their free end. This also permits play-free clamping. It is also easy to insert the projections 83 into the openings 55 and 12.

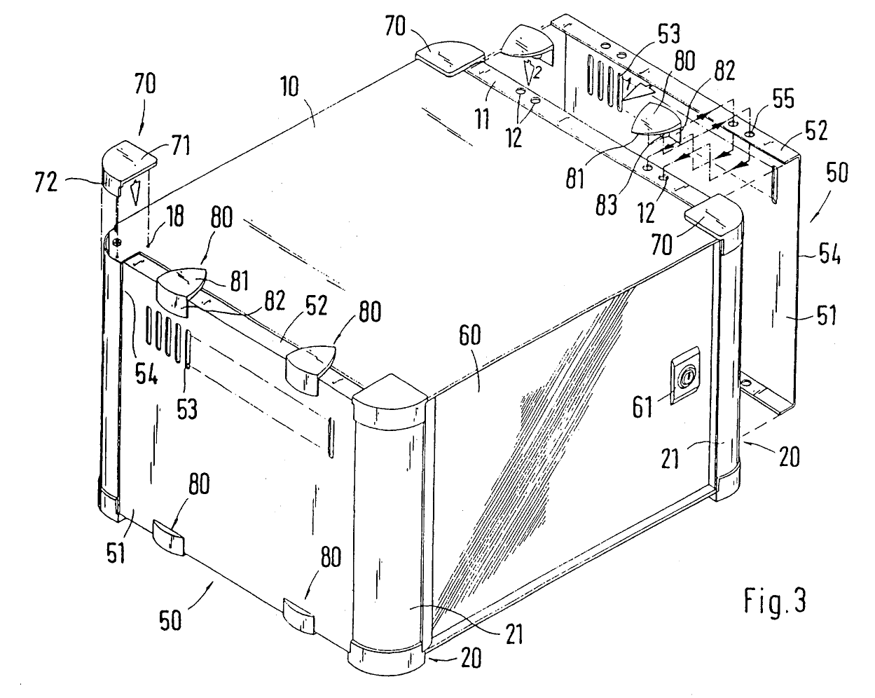

Caps 70 are used to complete the housing structure. The caps 70 have a horizontal plate 71 and an arc-shaped apron 72 formed onto them. Near their plate 71, the caps 70 have projections, which point toward the associated cover 10. As shown in FIG. 3, fastening receptacles 18 are led into the cover 10. The projections of the plate 71 can be inserted into the fastening receptacles 18, thus fixing the caps 70 in place.

DE 43 07 806 has disclosed a housing design, which has horizontally disposed profiled legs. The profiled legs are provided with several undercut grooves to which assemblies can be fastened.

DE 197 07 680 has disclosed a housing that can be wall-mounted. This housing has a base plate, which can be screwed to a wall. A hood-shaped cover can be fastened to this base plate. A number of undercut grooves are let into the base plate. These grooves can be used for fastening purposes.

The object of the invention is to produce a housing of the type mentioned at the beginning, which offers numerous fastening possibilities and in which the assemblies fastened to the profiled legs can also be varied in terms of their installation position.

This object is attained in that a supporting surface disposed perpendicular to the associated housing side adjoins the inner surface at right angles, that a second groove, which opens toward the rear of the housing, is let into the supporting surface, that a support for the fastening of sub-racks is secured to the first and/or second groove, and that when attached to the first groove, the support can be moved to the longitudinal span of the groove in the direction of the housing depth and that when attached to the second groove, the support can be moved lateral to the longitudinal span of the groove in the direction of the housing width. With this embodiment, the sub-racks to be fastened can be alternatively fastened to the first or the second groove. Depending on the sub-rack size, the supports can be fastened either to the first or the second groove. Moreover, the sub-racks can also be moved in a limited fashion in the housing interior.

A preferred embodiment of the invention provides that the front profiled legs have a supporting surface, which is disposed perpendicular to the housing front and has a third undercut groove let into it, and that this third groove opens toward the opposite front profiled leg. This third undercut groove further increases the fastening possibilities of the housing.

In particular, it is possible to provide that the front supporting surface is adjoined by a stop wall, which adjoins the supporting surface at right angles and is disposed at its back end, that the supporting surface, together with the stop wall, constitutes a receptacle for a hinge piece of a hinge for a door, and that the hinge piece is screwed to a sliding block contained in the third groove. Since the two front profiled legs are each provided with the third groove, it is easily possible to change the door stop style of the door.

So that access to the housing interior is not obstructed in an embodiment of this kind, it is possible to provide that this supporting surface is disposed parallel to and offset from the inner surface toward the housing side.

One possible variant of the invention can be embodied so that at least the front profiled legs have an outer surface, which encompasses the corner region of the housing and covers over an enclosed space of the profiled leg, that a screw channel extending in the longitudinal direction of the profiled leg is let into the enclosed space, and that the covers are screwed to the screw channels of the profiled legs. The outer surfaces optically complete the corner region of the housing.

If the housing is embodied so that the profiled legs have a profile side disposed at right angles to the outside of the housing, that the profile side is adjoined by an additional profile side, which is recessed in relation to the outside of the housing, and that the two profile sides form an external recess into which the edges of a side wall are inserted, then an optical integration of the side wall is achieved in a simple manner. In particular, the side wall can be inserted into the external recess in such a way that it transitions flush into the above-mentioned outer surface of the profiled legs.

Preferably, in a housing according to the invention, a profiled leg is disposed in each of the two front and rear housing corner regions. The profiled legs here are cross-sectionally identical, which on the one hand, achieves a simple housing structure and on the other, offers numerous fastening possibilities.

The invention will be explained in detail below in conjunction with exemplary embodiments shown in the drawings.

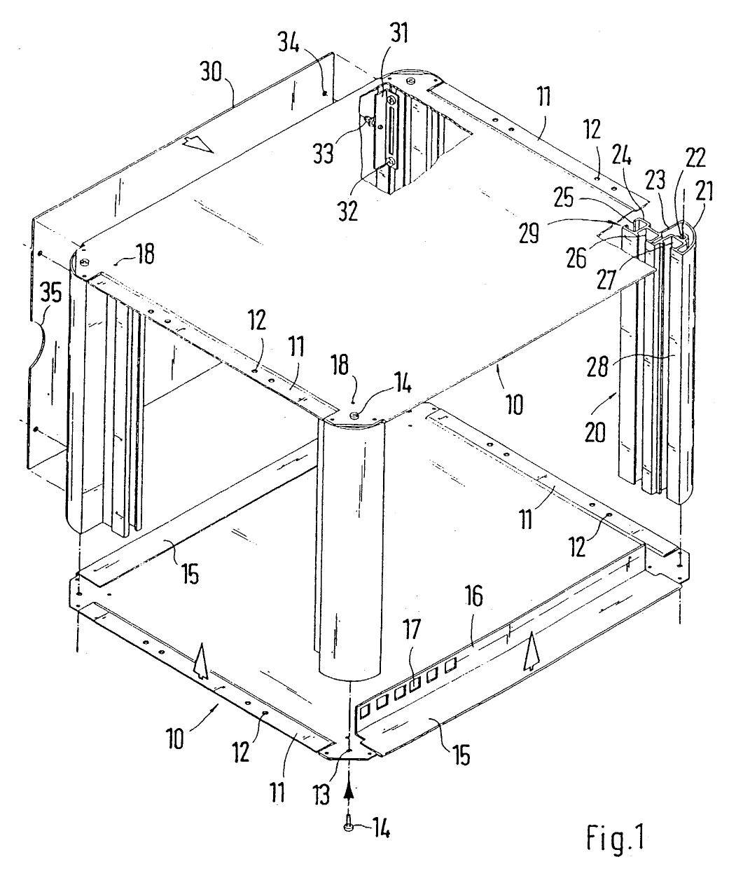

FIG. 1 shows an exploded, persepective view of a partial structure of a housing,

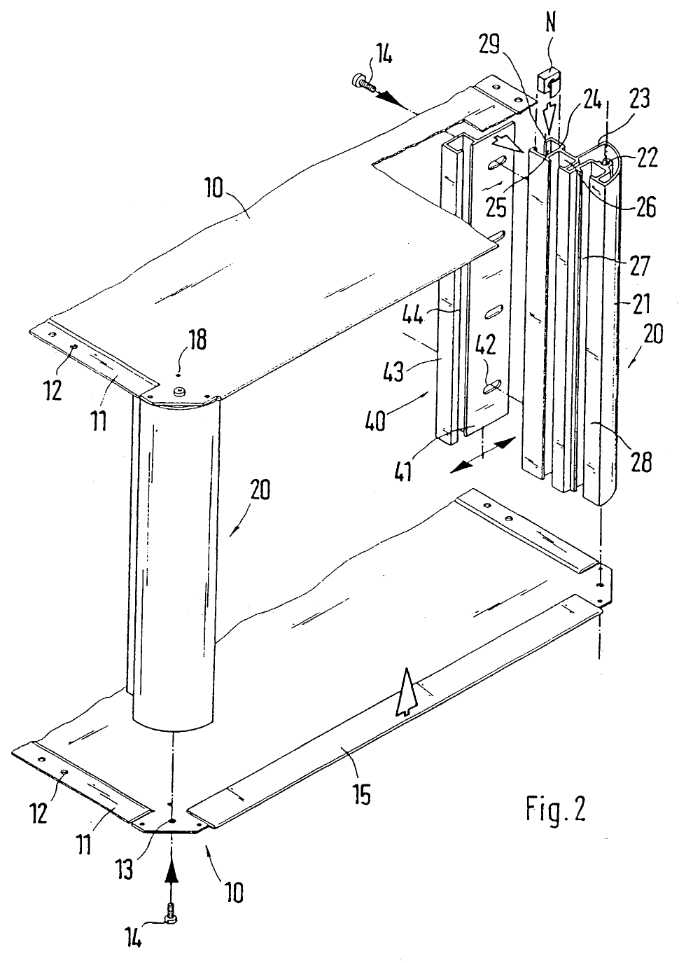

FIG. 2 shows a detail taken from FIG. 1, but with differently embodied bottom and top covers,

FIG. 3 shows a completed version of the partial housing shown in FIG. 1, and

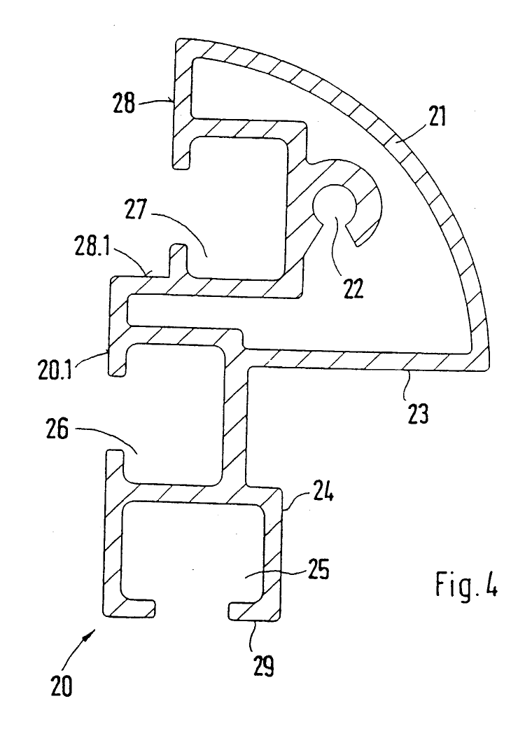

FIG. 4 shows a cross sectional view of a profiled leg of the housing according to FIGS. 1 to 3.

FIG. 1 shows a partial housing. It has two horizontal covers 10, which are produced from a plate-shaped blank and are embodied as stamped, bent parts. In the vicinity of their sides extending in the direction of the housing depth, the covers 10 have a folded flange 11. Four openings 12 are let into each of the flanges 11. The flange 11 extends parallel to the cover 10. However, it is disposed offset from this cover toward the interior of the housing. Screw receptacles 13 and fastening receptacles 18 are provided in the corner regions of the covers 10. The front edge of the cover 10 is provided with a folded edge 15 that is folded over by 180°. The folded edge 15 extends toward the rear of the housing. A flap 16 is bent at right angles from the folded edge 15. The flap 16 stands upright, parallel to, and spaced apart from the front of the housing. A row of fastening receptacles 17 is let into the flap 16. The row extends in the direction of the housing width. Since the top cover 10 is identical to the bottom cover 10, a flap 16 also protrudes into the housing interior at the top of the housing. Assemblies inside the housing can be attached to the fastening receptacles 17 of the flap 16. For example, sub-racks can be installed inside the housing, which are affixed to the flaps 16 on both sides.

Vertically extending profiled legs 20 are used to connect the two parallel covers 10. The profiled legs 20 are embodied as extruded profiles. The embodiment of the profiled legs 20 is shown in detail in FIG. 4. The profiled legs have a curved outer surface 21, which spans the corner region of the housing. In the vicinity of the housing side, the outer surface 21 is adjoined by a profile side 23, which extends at right angles to the associated housing side. The profile side 23 forms an external recess together with another profile side 24 that extends parallel to the housing side once more. The profile side 24 has a groove 25 at the end. This undercut groove 25 is open toward the rear of the housing (front profiled leg 20) or toward the front of the housing (rear profiled leg 20). Offset toward the front or rear of the housing, the profiled leg 20 has two additional grooves 26 and 27. The grooves 26 and 27 are also embodied with undercuts and open toward the interior of the housing. The grooves 25, 26, and 27 are embodied as cross-sectionally identical. Sliding blocks N with threads (see FIG. 2) can be inserted into the grooves 25, 26, and 27. Assemblies inside the housing can be attached to the sliding blocks N. The groove 27 is used for attaching a door 60, the details of which can be inferred from FIG. 3. The door 60 is hinge-mounted to either the left or right vertical profiled leg 20 by means of hinges. The hinges here are supported with one of their hinge pieces against a supporting surface 28. The supporting surface 28 adjoins the groove 27. Through the use of the above-described sliding blocks N, the hinge piece can be screwed to the profiled leg 20. Oriented toward the rear of the housing, the supporting surface 28 is adjoined by a stop wall 28.1. This stop wall 28.1, together with the supporting surface 28, forms a receptacle for the hinge piece. The hinge piece can be aligned exactly on the supporting surface 28 and the stop wall 28.1. This permits the hinge axes of several, for example two, hinges to be aligned exactly in relation to one another. Since the housing is embodied symmetrically and in particular, all of the profiled legs 20 are identical, the doorstop style of the door 60 can be easily changed. The door 60 can be locked by means of a lock 61. The lock 61 is embodied as a casement lock. When locked, the casement lock engages in the groove 27 of the right front profiled leg 20. Supports 40 can be fastened to the grooves 25 and 26. FIG. 2 shows an example of a possible embodiment of a support 40. The support 40 has a fastening section 41, which is provided with a number of oblong holes 42. The fastening section 41 has a support piece 43, which is embodied with an undercut groove 44. The undercut groove 44 is open toward the front of the housing. The support 40 can rest with its fastening section 41 against a supporting surface 29. This supporting surface 29 adjoins the groove 25. In order to fasten the support 40, fastening screws 14 are inserted through the oblong holes 42 and screwed into the sliding blocks N that are contained in the groove 25. This clamps the front of the fastening section 21 to the supporting surface 29. As shown in FIG. 2, the support 40 can be slid back and forth horizontally. The fastening screws 14 need only be loosened to permit this movement. Then the support 40 can be brought into the desired position by means of the oblong holes 42. Preferably, the ends of the oblong holes 42 define two set positions. The one set position can define a first standard spacing between two supports 40 attached to the two front frame egs 20 (for example a 10″ spacing). In the second set position, the second standard installation dimension (for example 9.5″) is defined by the grooves 44 of the supports 40. In lieu of or in addition to the support 40, a support can also be fastened to the groove 26. This support then rests against an inner surface 20.1 of the profiled leg 20 and can be moved on it in the direction of the housing depth.

As shown in FIG. 1, the vertical profiled legs 20 have a screw channel 22 formed onto and of one piece with them, extending in the longitudinal direction of the profile. The profiled legs 20 can be placed with their ends against the insides of the covers 10. The screw channel 22 is then flush with the screw receptacle 13 of the associated cover 10. A fastening screw 14 can be inserted through the screw receptacle 13 and screwed into the screw channel 22. This permits the vertical profiled legs 20 to be connected to the two covers 10 to form a housing frame.

A back wall 30 can be attached to this housing frame. The back wall 30 is embodied as a sheet metal plate and has fastening receptacles 34 in the vicinity of its vertical edges. Fastening angles 31 can be attached to both of the rear vertical profiled legs 20. The fastening angles 31 are attached to the rear groove 27 of the profiled legs 20 by means of fastening screws 32. The fastening angles 31 have connectors 33, which protrude with detent projections toward the rear of the housing. The back wall 30 can be detent-connected to these detent projections by means of the fastening receptacles 34. In the vicinity of at least one of its vertical sides, the back wall 30 is provided with a semicircular cutout 35. A user can grasp this cutout 35 and, by pulling, can detach the back wall 30 from the connectors 33.

FIG. 2 shows an embodiment of a housing, which is essentially identical to the embodiment of the housing according to FIG. 1. The only difference between the two housings lies in the embodiment of the covers 10. In contrast to the covers 10 according to FIG. 1, the covers 10 according to FIG. 2 do not have flaps 16 with fastening receptacles 17.

The housings according to FIG. 1 and FIG. 2 can be enclosed by means of side walls 50. FIG. 3 shows the embodiment of the side walls 50 and the way in which they are attached to the housing. As shown in this drawing, the side walls 50 have a vertical wall 51. This wall 51 is provided with bent edges 52 on its horizontal sides. In its upper region, the wall 51 has a row of ventilation slots 53. The edges 52 of the side wall 50 are provided with four openings 55. The openings 25 are associated with each other in pairs. In order to install the side wall 50, it is inserted into the external recesses of the vertical profiled legs 20. As mentioned above, the external recesses of the profiled legs 20 are defined by the profile sides 23 and 24. When the side wall 50 is inserted, the vertical edges 54 of the side wall 50 are aligned so that the wall 51 transitions flush into the outer surface 21 of the profiled legs 20. The edges 52 of the side wall 50 overlap the flanges 11 of the covers 10. In so doing, the openings 55 of the edges 52 are disposed flush with the openings 12 of the flanges 11. Fasteners 80 are used to attach the side walls 50. The fasteners 80 are embodied as plastic elements formed out of a flexible material. They have a vertical top section 81, which is adjoined at right angles by a wall section 82. The top section 81 has projections 83 formed onto it, which protrude toward the flange 11. Each fastener 80 is provided with two projections 83. The projections 83 engage in the openings 55 and 12 of the edges 52 and the flanges 11. When installed, the faster 80 rests with its top section 81 against the top of the cover 10 and the edge 52. The wall 51 rests against the outside of the side wall 50. Since the round projections 83 are comprised of a flexible material, they are clamped over their entire circumference against the inner contour of the openings 55 and 12. This permits a play-free attachment of the side wall 50. It is also conceivable for the projections 83 to be embodied conically so that from the point at which they adjoin the top section 81, they taper toward their free end. This also permits play-free clamping. It is also easy to insert the projections 83 into the openings 55 and 12.

Caps 70 are used to complete the housing structure. The caps 70 have a horizontal plate 71 and an arc-shaped apron 72 formed onto them. In the vicinity of their plate 71, the caps 70 have projections, which point toward the associated cover 10. As shown in FIG. 3, fastening receptacles 18 are let into the cover 10. The projections of the plate 71 can be inserted into the fastening receptacles 18, thus fixing the caps 70 in place.

1. A housing for containing electric and/or electronic assemblies, with two parallel plate-shaped covers, which are connected to each other by means of profiled legs extending vertically with respect to the planes of the covers, in which the profiled legs are embodied as extruded profiled sections and are provided with undercut grooves formed onto and of one piece with them, in which the two profiled legs oriented toward the front of the housing each have an inner surface extending vertically with respect to the front of the housing, and a first undercut groove, which opens toward the interior of the housing, is let into these inner surfaces, characterized in that a supporting surface (29) disposed perpendicular to the associated housing side adjoins the inner surface (20.1) at right angles, that a second groove (25), which opens toward the rear of the housing, is let into the supporting surface (29), that a support (40) for the fastening of sub-racks is secured to the first and/or second groove (26 and/or 25), and that when attached to the first groove (26), the support (40) can be moved to the longitudinal span of the groove in the direction of the housing depth and that when attached to the second groove (25), the support (40) can be moved lateral to the longitudinal span of the groove in the direction of the housing width.

2. The housing according to claim 1, characterized in that the front profiled legs (20) have a supporting surface (28), which is disposed perpendicular to the housing front and has a third undercut groove (27) let into it, and that this third groove (27) opens toward the opposite front profiled leg (20).

3. The housing according to claim 2, characterized in that the front supporting surface (28) is adjoined by a stop wall (28.1), which adjoins the supporting surface (28) at right angles and is disposed at its back end, that the supporting surface (28), together with the stop wall (28.1), constitutes a receptacle for a hinge piece of a hinge for a door (60), and that the hinge piece is screwed to a sliding block (N) contained in the third groove (27).

4. The housing according to one of claims 2 or 3, characterized in that the supporting surface (28) is disposed parallel to and offset from the inner surface (20.1) toward the housing side.

5. The housing according to one of claims 1 to 4, characterized in that at least the front profiled legs (20) have an outer surface (21), which encompasses the corner region of the housing and covers over an enclosed space of the profiled leg (20), that a screw channel (22) extending in the longitudinal direction of the profiled leg is let into the enclosed space, and that the covers (10) are screwed to the screw channels (22) of the profiled legs (20).

6. The housing according to one of claims 1 to 5, characterized in that the profiled legs (20) have a profile side (23) disposed at right angles to the outside of the housing, that the profile side is adjoined by an additional profile side (24), which is recessed in relation to the outside of the housing, and that the two profile sides (23, 24) form an external recess into which the edges of a side wall (50) are inserted.

7. The housing according to one of claims 1 to 6, characterized in that a profiled leg (20) is disposed in each of the two front and rear housing corner regions and that the profiled legs (20) are embodied as cross-sectionally identical.
